(19) United States
(12) Patent Application Publication
(10) Pub. No.: US 2010/0261807 A1
(43) Pub. Date: Oct. 14, 2010

(54) NOVEL DISPERSIONS AND METHOD FOR THE PRODUCTION THEREOF

(76) Inventors: Christiane Laine, Espoo (FI); Soili Peltonen, Espoo (FI); Sari Hyvarinen, Espoo (FI); Bjorn Krogerus, Espoo (FI); Hannu Mikkonen, Espoo (FI); Heikki Pajari, Espoo (FI); Mika Vaha-Nissi, Espoo (FI)

Correspondence Address: MCCORMICK, PAULDING & HUBER LLP, CITY PLACE II, 185 ASYLUM STREET, HARTFORD, CT, 06103, US

(21) Appl. No.: 12/602,546

(22) PCT Filed: Jun. 2, 2008
(86) PCT No.: PCT/FI08/50320

§ 371 Date: Jun. 22, 2010

(30) Foreign Application Priority Data
Jun. 1, 2007 (FI) 20075399

(51) Int. Cl. C09D 5/16; C08L 67/04; C08K 3/34; C08K 3/30; C08K 3/26; C08K 3/22; C08J 3/02

(52) U.S. Cl. 523/122; 524/599; 524/447; 524/449; 524/451; 524/421; 524/442; 524/425; 524/437; 524/413; 524/501

(57) ABSTRACT

An aqueous dispersion comprising a non-settling colloidal hemicellulose ester polymer in water and a method of producing the same. In the method an esterified hemicellulose is provided wherein at least a part of the esterifying groups are derived from a lower alkanoic acid; the esterified hemicellulose is dissolved in an alkanoic acid to produce a solution; and the solution is dispersed into water to produce an aqueous dispersion of the hemicellulose ester. The present compositions, containing hemicellulose derivatives of low solubility, can be used in paper, paperboard and other fibre-based materials, for paints, surface treatments for polymer films, and polymer films as such, and can be applied as binders.

### CROSS REFERENCE TO RELATED APPLICATIONS

This application is entitled to the benefit of and incorporates by reference essential subject matter disclosed in International Patent Application No. PCT/FI2008/050320 filed on Jun. 2, 2008 and Finnish Patent Application No. 20075399 filed Jun. 1, 2007.

### FIELD OF THE INVENTION

The present invention relates to hemicellulose ester dispersions.

A dispersion of this kind comprises a hemicellulose ester in an aqueous medium.

The present invention also concerns a method for the production of hemicellulose ester dispersions, and to the use of them.

### BACKGROUND OF THE INVENTION

Pigment coatings of paper, paperboard and similar surfaces conventionally contain petrochemically-based synthetic binders. These synthetic coating binders and dispersion coatings are based on, for example, styrene-butadiene (SB), styrene acrylate (SA) and other acrylate copolymers, and polyvinyl acetate (PVAc). Natural polymer starch and its modifications have been employed as sizing chemicals and also as coating binders. However, the most commonly applied starches are water-soluble substances having drawbacks/limitations in coating applications of e.g. printing papers (such as need for cooking, low solids content and lower print quality/more mottling, poorer optical properties, low water resistance, and tendency for cracking in fold).

There is an increasing pressure on cost reduction in papermaking due to a long-term decrease of paper prices. Coating accounts for approximately 28% of the paper price. In March 2006, the price of latex is about 1,430 and 1,870 [symbol] /dry t for SB and SA latex, respectively, whereas the price of potato starch was only about 330 [symbol] /t. The volume of latex used for paper and board production in Europe is approximately 700,000 t dry latex/y. The raw material for any potential new binder must therefore be available in large scale.

Hemicelluloses are natural polymers present in, for example, annual and perennial plants. Beside cellulose they are the most abundant natural polymers in nature: depending on plant species, 20 to 30% by weight of the dry matter is formed by hemicelluloses and approximately 3×10¹⁰ ton of hemicelluloses is being photosynthetized each year by living plants. Hemicelluloses have so far found only limited application in industry, and they are primarily being used as raw-materials for the production of fine chemicals, such as xylose and other monosacharides, by various hydrolyzation methods. Otherwise, hemicelluloses are typically leached into the cooking liquor of alkaline cooking processes and combusted in the soda kiln.

### SUMMARY OF THE INVENTION

The present invention is based on the idea of utilizing hemicelluloses as functional or modifying polymers, in particular in the paper and pulp industry. As noted above, other natural polymers, such as starch and also some cellulose derivatives (e.g. CMC), are already being used as binders, sizing and thickening agents and even as organic pigments, but native hemicelloses are not in use as such or in derivatized form.

It has been found that the free hydroxyl groups of isolated hemicelluloses, such as xylan, can be converted to ester groups by simple esterification procedures. In particular, the free hydroxyl groups can be acetylated so as to provide an acetyl content of up to 50 wt-% by a heterogeneous acetylation method in an organic media, such as acetic acid. Esterification of the above kind makes it possible to regulate the hydrofilicity and hydrofobicity of the hemicellulose, and to tailor them for new applications.

One particularly interesting starting material is xylan which is abundantly available and readily extractable from hardwood and hardwood products. Xylan is primarily present in hardwood as O-acetyl-4-O-methylglucuroxylan. The main chain is formed by beta-D-xylopyranose units bonded by 1->4 glycoside bonds, and a part of the hydroxyl groups in position C-3 is replaced by acetyl groups (there are about 7 such groups per 10 xylose units). For each 10 xylose units there is further a 4-O-methyl-alfa-D-glucuronic acid group. During pulping and during extractive/alkaline isolation, the acetyl groups and most of the glucuronic groups are split off, converted to hexenuronic acids or otherwise degraded.

According to the present invention, hemicelluloses, such as essentially linear hemicelluloses, are esterified with an esterifying agent capable of introducing the residue of an organic acid. For example, for preparing acetate derivatives of xylan, the esterifying agent can be selected from the group of acetic acid, acetic acid anhydride and mixtures thereof, to yield a xylan ester, such as xylan acetate, a compound which is sparsely soluble in water and in many common solvents. It has also a high glass transition temperature. Xylan esters can be used in applications where low solubility in water is aimed at, for example as pigments and binders.

According to one embodiment of the invention, the present invention provides the hemicellulose esters in the form of aqueous dispersions formed by a non-settling colloidal hemicellulose ester polymer in water.

The present derivatives and dispersion can be used as binders in coating compositions for paper and paperboard products as well as paints and as adhesives for example in wood composites; they can also be used as pigments and fillers in paper and paperboard, in paint and in rubber and similar polymers.

More specifically, the dispersion comprises a non-settling colloidal hemicellulose ester polymer in water.

The method of producing a stable dispersion comprises the steps of providing an esterified hemicellulose wherein at least a part of the esterifying groups are derived from a lower alkanoic acid; dissolving the esterified hemicellulose in formic acid to produce a solution having a volume; diluting said solution with water; and dispersing the water-diluted solution into a volume of water which is greater than the volume of the original ester solution to produce an aqueous dispersion of the hemicellulose ester.

The uses according to the invention are characterized by what is stated in claims 18 to 34.

Considerable advantages are reached with the aid of the invention. The new dispersion-based products perform well in terms of recyclability. Oil-based chemicals currently used in certain applications can be replaced with these new chemicals from renewable resources. This provides an opportunity to decrease the dependence from oil-based chemicals and a step towards more sustainable materials. Further, it should be noted that the present aqueous dispersions are free of volatile organic components. By contrast, in the art, esters of hemicelluloses have been made using organic solvents, such as pyridine and dimethyl formamide, which causes a need for extra processes for cleaning of the product. Naturally, solvent-free compositions of the present kind are desirable in many applications.

Next the invention will be examined in more closely with the aid of a detailed description and a number of working examples.

### BRIEF DESCRIPTION OF THE DRAWINGS

In the attached drawings,

FIGS. 1a to 1c are electron microscope images with different magnifications of a dispersion according to Example 7; and

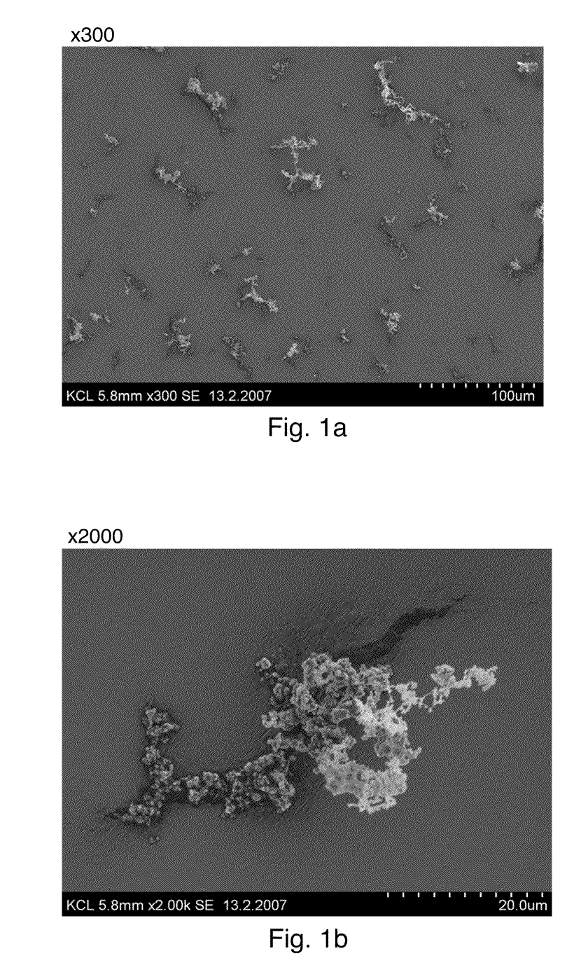

FIG. 2 is a bar chart showing the optical properties of the coated and calendered sheets according to Example 10.

### DETAILED DESCRIPTION OF THE PREFERRED EMBODIMENTS

In the following description, the invention is disclosed with particular reference to xylan.

However, it should be understood that it is equally applicable—mutatis mutandis—to other hemicellulose species, in particular to other hemicelluloses which have a basically linear configuration, such as glucans with the same orientation of hydroxyl groups as xylans at position 2 and 3, which makes them sparsely soluble in conventional solvents, in particular in water. Possibly the same properties can be obtained from derivatives of water-soluble (galacto)glucomannans. The preferred hemicelluloses are derived from wood and tree, in particular from species of deciduous trees. They can be isolated for example by alkaline extraction directly from the wood itself (e.g. from wood chips) or from cellulosic or lignocellulosic pulp prepared from the wood raw material. Also other plant materials than wood can be used as a source of the hemicelluloses.

The present invention provides aqueous dispersions comprising a non-settling colloidal hemicellulose ester polymer in water.

For the purpose of the present invention, a colloid mixture is a heterogeneous mixture where small particles of one substance are distributed evenly throughout another substance. The particles of a colloid mixture have typically one characteristic dimension, which is between about 1 and 1500 nm, preferably in the range of 1 nm to 1000 nm.

The dispersion is considered to be non-settling if, upon standing at room temperature for at least 24 hours, less than 10 wt-% of the total amount of solids of the dispersion is precipitated or settled out.

The dispersion may comprise other components, but according to one embodiment it consists or consists essentially of the hemicellulose ester in water.

For the dispersion, the hemicellulose ester is selected from esters of xylan, glucan, glucomannan and (galacto)glucomannan. The hemicellulose ester is derived from a lower alkane acid, in particular the hemicellulose ester is a hemicellulose formate, acetate, propionate or butyrate. The hemicellulose ester is essentially insoluble or sparsely soluble in polar solvents (referred to in the following as “ester of low solubility”). In practice, less than 10%, typically less than 5% and in particular less than about 2% by weight of the ester is dissolved in a polar solvent such as water or a lower alcohol at room temperature during dissolution times of 2 to 10 hours.

The dispersion typically has a solids content of 5 to 70%, preferably between 30 and 50%, calculated from the total weight of the dispersion. The dispersion comprises hemicellulose ester particles at least some of which form flocs or agglomerates.

Of these flocs or agglomerates, a majority, typically at least 75 or at least 80% are smaller than 35 um. As can be seen from the results below, in one specific case 96% were smaller than 35 um, as determined with a laser particle size analyzer.

The hemicellulose ester exhibits a degree of esterification of 5 to 50%, preferably about 25 to 50%, based on the total weight of the hemicellulose ester.

According to a preferred embodiment, the dispersion comprises xylan acetate, formed from a linear chain of beta-D-xylopyranose units, wherein the acetyl content is 5 to 50%, calculated from the weight of the hemicellulose derivative. The xylan acetate of the molecular weight indicated below is essentially insoluble in water and lower (═C₁ to C₄) alcohols.

The pH of the aqueous hemicellulose ester dispersions according to the present invention is about 3 to 8.5, preferably 7.0 or below, typically about 4.5 to 6.5.

The xylan ester is applied as such or with pigments and other additives to paper, paperboard and similar surfaces, or as a sizing chemical to pulp furnishes.

The form of application is, however, preferably as dispersion. The dispersions can be prepared by conventional dispersing technology, e.g. by dissolving the xylan ester in a suitable solvent and by dispersing the solution into water under stirring and by using dispersing agents.

According to a preferred embodiment, the present invention provides a novel, simplified method of producing a stable dispersion. It comprises the steps of
providing an esterified hemicellulose wherein at least a part of the esterifying groups are derived from a lower alkanoic acid;
dissolving the esterified hemicellulose in formic acid to produce a solution, and
dispersing said solution into water to produce an aqueous dispersion of the hemicellulose ester.

Using this embodiment, a stable aqueous dispersion is obtained without additional chemicals. No protective colloids are needed. This has been demonstrated for a fully acetylated xylan ester from birch sulphate pulp. However, the results are equally good with other kinds of xylan, for example xylan isolated from annual plants (cf. example with barley xylans below).

The dispersion can optionally be washed and concentrated, but it is already stable as such.

According to a preferred embodiment, the invention comprises the steps of first providing a hemicellulose having at least some hydroxyl groups, and reacting the hemicellulose with an esterification agent to produce an esterified hemicellulose. The esterified hemicellulose thus produced is dissolved in a solvent and the solution obtained is dispersed into water to produce an aqueous dispersion of the ester.

Preferably, no additional chemicals are used for preparing the aqueous dispersion.

According to a preferred embodiment, the hemicellulose is esterified with a short chain aliphatic carboxylic acid. Typically the carboxylic acid has 1 to 10 carbon atoms, and in particular it has the formula

CH₃(CH₂)ₙCOOH

wherein n is an integer 0 to 3.

Esterification can be carried out in an analogous fashion as for starch, described in detail in earlier patents assigned to Valtion teknillinen tutkimuskeskus (VTT), cf. U.S. Pat. Nos. 6,369,215 and 6,605,715. One particularly preferred embodiment comprises acetylation of the starting material. In such a process, the alkali used for isolating hemicellulose from a plant raw-material can be employed as a catalyst for the acetylation reaction, which removes the need for separate purification of the raw-material.

Depending on the hemicellulose, the degree of substitution varies. Taking hardwood xylan as an example, in a particularly preferred embodiment, an ester is produced having a degree of substitution in excess of 1.5, preferably 1.75 or more, in particularly about 1.9 or more. For glucomannans and other hemicelluloses having three or more substitution sites, the degree of substitution is usually at least (or in excess of) 2.0, preferably at least 2.5 or even 2.75 after esterification.

After esterification, the ester product is dissolved in an organic carboxylic acid. Preferably an alkanoic acid capable of dissolving the esters is used. The alkanoic acid typically has 1 to 6 carbon atoms, preferably 1 to 4 carbon atoms. An advantageous embodiment is formic acid, optionally in aqueous solution. The concentration of formic acid is at least about 80% by weight, in particular higher than 90% by weight. If possible 100% formic acid is used. The formic acid can be employed in the form of a azeotropic composition with water.

During dissolution of the ester into the alkanoic acid, new ester groups can be formed by a reaction of free hydroxyl groups present on the hemicellulose and the alkanoic acid during dissolution. This is illustrated by the preferred embodiment, wherein xylan acetate is dissolved in formic acid: acetylated xylan reacts with formic acid leading to the formation of a mixed ester containing both acetate and formyl groups.

In order to produce an aqueous dispersion of the dissolved ester, water is added to the solution up to a point where the solution does not take up more water. In practice, water is added until the cloud point is reached. Typically, the amount of water added is 0.1 to 10 times the volume of the solution, preferably about 0.5 to 2.0 times the volume of the solution.

After this point, flash dilution is carried out in order to disperse the polymer into water in the form of minute particles. In practice, flash dilution can be carried out by dispersing the solution under intensive agitation in a turbulent mixing zone into a large volume of water which typically is 1.5 to 50 times, preferably 2 to 20 times, greater than the volume of the original ester solution. In order to achieve flash dilution, the time required for the dilution is, depending on the volume of pre-diluted aqueous dispersion, generally on the order of about 0.1 min to 6 hours, preferably about 0.5 min to 30 min, in particular about 1 to 10 min.

Finally, the dispersed phase can be concentrated and washed with a various methods, including ultrafiltration, microfiltration and centrifugation or a combination thereof.

As a result is obtained a pure polymer dispersed in water typically at a pH below 7, typically at less than 6, in particular at about 5.

The starting material, i.e. typically linear hemicellulose, has for example an average molar mass M_{w} in the range of about 1,000 to 50,000 g/mol, in particular about 5,000 to 25,000, preferably about 7,500 to 20,000 g/mol, and a polydispersity of about 1.1 to 5.0, in particular about 1.5 to 2.5. When using xylan as an example, the hemicellulose can be extracted from wood, pulp or agricultural sources. The extraction liquid is separated by e.g. filtration. The xylan is precipitated or otherwise separated from the liquid. Other hemicelluloses are isolated in similar fashion.

The hemicellulose ester has an average molar mass M_{w} in the range of about 1,000 to 30,000 g/mol, in particular about 5,000 to 20,000, preferably about 7,500 to 17,500 g/mol, and a polydispersity of about 1.2 to 4.0, in particular about 1.5 to 2.5.

One suitable process for extracting hemicelluloses from the bleached pulp at alkaline conditions is discussed in International Patent Application PCT/FI2006/000406 (Oy Keskuslaboratorio—Centrallaboratorium Ab), the contents of which is herewith incorporated by reference. The extracted pulp slurry is filtered, and the filtrate is poured into isopropanol. The precipitate can be concentrated, and washed to remove possible extractive residues.

Dissolved xylan obtained by such extraction can be precipitated for example by precipitation—after neutralization—into 1 to 4 volumes ethanol, preferentially 2 volumes. Another possibility is precipitation without prior neutralization into 0.5 to 2 volumes of isopropanol as described for the precipitation of oat spelt xylan (Puls, J., Schröder, N., Stein, A., Janzon, R., Saake, B. (2006) Xylans from Oat Spelts and Birch Kraft Pulp, Macromol. Symp. 232, 85-92). The precipitate can be concentrated e.g. by centrifugation and if necessary in a (vacuum) oven.

In the examples below, the designation “KCL xylan” is used for xylan precipitated according to the above scheme.

The “KCL xylan” had for example an average molar mass M_{w} of 14,000 g/mol and a polydispersity of 1.8. The carbohydrate composition after hydrolysis was (announced as monosaccaharides): Xylose 57 mg/100 mg, Arabinose 0.1 mg/100 mg, Galactose 0.1 mg/100 mg, Glucose+, Rhamnose+, Mannose−, 4-O-methylglucuronic acid 1.3<mg/100 mg. Ash content: 35% (525° C.), 21% (900° C.). Generally, the “KCL xylan” has very few side groups as can be seen from the chemical analysis, being an essentially linear, unbranched xylan.

Another starting material comprised Sigma Xylan from oat spelts.

### Properties:

Composition: arabinose≦10% HPAE, glucose≦15% HPAE, Xylose≦70% HPAE (after hydrolysis). Solubility: 1 M NaOH: may be turbid

According to one aspect of the invention, natural polymer-based compositions, containing hemicellulose derivatives of low solubility, are produced which have potential for paper, paperboard and other fibre-based materials, for paints, surface treatments for polymer films, and polymer films as such, and which can be applied as binders.

Incorporated into or forming, as such, a layer the xylan ester exhibits good resistance to water and solvents due to its low solubility. Applications for the present xylan esters therefore include also e.g. barrier layers in packaging and other materials.

The compositions can be used for modifying various surfaces, which refers to internal or surface sizing, impregnating, coating, painting, printing, lacquering or the like.

Basically, the present polymer is in the form of aqueous dispersion. The polymer composition, formulated for modification of surfaces, further may comprise pigments, in particular particles selected from the group consisting of gypsum, silicate, talc, plastic pigment particles, kaolin, mica, calcium carbonate, including ground and precipitated calcium carbonate, bentonite, alumina trihydrate, titanium dioxide, phyllosilicate, synthetic silica particles, organic pigment particles and mixtures thereof. The proportion of pigment is typically between 0 and 97%, most typically between 30 and 95% calculated as dry matter.

The polymer composition may further comprise in addition one or more additional components. Such additional component can be selected from the group consisting of antifoaming agents and salts, defoaming agents and salts, biocides and preservatives, surface tension agents, water retention agents, rheology modifiers, plasticising agents, lubricants, optical brightening agents, colouring agents, cross-linkers, waxes, dispersants, dispersing agents, volatile alkalis and hydrophobic agents.

With the aid of the invention, a number of substrates can be treated and modified. Examples of such substrates are kraft paper, paperboard, cardboard, corrugated board, ream wrap, printing paper, greaseproof paper and the like. Also plastic substrates, polymer film, polymer coated paper, polymer coated paperboard, non-woven and the like can be treated, as can wood, concrete, stone, metal, brick, veneer, fibrewood, fibreglass and the like.

The polymer can be used as such, i.e. as the only polymer component of the coating or surface treatment composition, or it can be admixed with from 10 to 99 parts, preferably less than 50 parts by weight of a water-soluble component and the admixture is applied to a substrate. The water-soluble component typically is selected from the group consisting of starch, polyvinyl alcohol, dextrin, protein, carboxymethyl cellulose, water-soluble hemicelluloses and resins and mixtures thereof.

According to a preferred embodiment of this kind, the hemicellulose polymer is admixed with from 10 to 99 parts, preferably less than 50 parts by weight of a second dispersed component and the admixture is applied to a substrate. The second dispersed component can be a conventional latex dispersion, wherein the binder is selected from the group consisting of butyl acrylate/methyl methacrylate, butyl acrylate/styrene, styrene/butadiene, and vinyl acetate dispersions and mixtures thereof.

It has been found that base paper can easily be coated with coating colors containing xylan acetate dispersion as binder component. Good optical properties in terms of gloss, brightness, opacity and light scattering can be reached.

The following non-limiting examples illustrate the invention.

In the examples, the “acetyl content” is indicated. The acetyl content is determined by hydrolysing the acetyl groups from the ester with an alkali (KOH-ethanol) and by titering the superfluous KOH with hydrochloric acid using phenophthalein as an indicator. The result is compared with the reference formed by the non-acetylated starting compound.

The acetyl percentage is calculated from the formula:

% A=(Vₒ−Vₙ)*N*0.043*100/M

wherein

% A=acetyl content,

Vₒ=consumption of HCl, reference, ml

Vₙ=consumption of HCl, sample, ml

N=normality of HCl solution

M=sample size (dry matter), g

43=molecular weight of the acetyl group

### Example 1

### Production of Hemicellulose-Acetate Using Sodium Hydroxide as a Catalyst

Oat based xylan (Sigma Xylan from Oat Spelts) was used as a hemicellulose starting material. Acetic acid (200 g) and acetic anhydride (116 g) were mixed together and added to a round-bottom reactor equipped with a mixer and a reflux condenser. Hemicellulose (30 g) was slurried in the mixture and then the temperature of the reaction mixture was raised to +40° C. A 50% aqueous solution of sodium hydroxide (6.6 g, equaling 22% of the amount of the hemicellulose) was cautiously added as a catalyst. After the addition of the catalyst the temperature of the reaction mixture was raised to +115° C. The reactants were allowed to react for 6 h, during which time the mixture partly gelled. The hemicellulose acetate was precipitated from the water and was washed until the pH of the filtrate was 5. The precipitate was dried in a hot cupboard.

Acetyl content: 35.2% based on the conversion of hydroxyl groups to acetyl groups.

Dry matter concentration: 90.6%

### Example 2

### Production of Hemicellulose Acetate Using Sulphuric Acid as a Catalyst

Oat based xylan (Sigma Xylan from Oat Spelts) was used as a starting material.

Acetic acid (150 g) and acetic anhydride (150 g) were mixed together and added to a reactor equipped with a mixer and a reflux condenser. Into the mixture strong sulphuric acid (0.1 g) was cautiously added. Hemicellulose (30 g) was slurried in the mixture and was allowed to mix for 15 minutes at the room temperature after which the temperature of the reaction mixture was raised to +50° C. and the reaction was continued for 3 hours. The hemicellulose acetate precipitate was washed several times with water and was dried in the hot cupboard.

Acetyl content: 5% based on the total weight of the product. Dry matter concentration: 91.5%

### Example 3

### Production of Hemicellulose Acetate Using Base Present in the Starting Material as a Catalyst

Hemicellulose isolated from birch (KCL xylan) was used as a starting material. Acetic acid (200 g) and acetic anhydride (116 g) were mixed together and added to a round-bottomed reactor equipped with a mixer and with a reflux condenser. Hemicellulose (20 g) was slurried into the mixture and the reaction mixture was slowly heated up to +115° C. and was allowed to react for 6 h. The precipitate was washed with water until the pH of the filtrate was 5. The precipitate was dried in a hot cupboard.

Acetyl content: 46.8% based on the total weight of the product. Dry matter: 95%

The glass transition temperature of the xylan acetate was 206° C. and it was extremely sparsely soluble in water and in most common organic solvents.

### Example 4

### Production of Hemicellulose Acetate Using the Base Present in the Starting Material as a Catalyst

### Test 1

Hemicellulose isolated from birch (KCL xylan) was used as a starting material.

Acetic acid (1000 g) and acetic anhydride (580 g) were mixed together and added to a round-bottomed reactor equipped with a mixer. Hemicellulose (100 g) was slurried into the mixture. The reaction mixture was slowly heated up to +115° C. and the reaction was continued for 6 h. The precipitate was washed with water until the pH of the filtrate was 5. The precipitate was dried in a hot cupboard.

Acetyl content: 44.3% based on the total weight of the product. Dry matter concentration: 96.7

Average molar mass M_{w} of 9,400 g/mol and polydispersity of 2.5.

### Test 2

Birch xylan (20 g) supplied by KCL (KCL xylan) was suspended in 200 g acetic acid and mixed over night. The temperature of the mixture was increased to 60° C. and 18.5 g acetic anhydride was added and mixing was continued for 1 hour. Then, the temperature of the reaction mixture was raised to 100° C. and a further 37 g of acetic anhydride was added and the temperature raised to 115° C. for 6 hours. The reaction mixture was poured into water, the precipitate was filtered and washed with water until the pH of the filtrate was >5. The product was dried.

The dry matter of the sample was 95.6% and the acetyl content 29.5% %.

Average molar mass M_{w} of 12,600 g/mol and polydispersity of 2.2.

### Test 3

5 g of glucomannan from spruce sulphite process was acetylated using the same method as described in test 2. The amounts of acetic acid and acetic anhydride were 40 g and 29 g, respectively. The acetyl content of the acetylated glucomannan was 34% and solid content 90.3%.

### Example 5

### Production of Hemicellulose Acetate in Aqueous Slurry

Oat based xylan (Sigma Xylan from Oat Spelts) was used as a starting material.

The hemicellulose was mixed in water to yield a 10% aqueous solution. The pH of the mixture was adjusted to a value in the range from 8.00 to 8.50 by adding an amount of aqueous solution of sodium hydroxide. Acetic anhydride (58 g) was added drop-wise to the mixture which was kept in a round-bottom reactor equipped with a mixer. The change of pH was monitored and if necessary sodium hydroxide was added. The reaction was allowed to proceed for 4 h at room temperature. The precipitate was washed and the adjustment of pH and the addition of the sodium hydroxide were repeated. Reaction was continued at room temperature for a further 4 h. The precipitate was washed with abundant water and was dried in a hot cupboard.

Acetyl content: 9.76% based on the total weight of the product. Dry matter: 89.6

### Example 6

### Production of a Hemicellulose Acetate Dispersion

First, 3 g of hemicellulose acetate made according to Example 4 (Test 1) was dissolved by heating at 40-60° C. in 100 ml of 100% formic acid, and then the solution obtained was mixed at room temperature for 12 h. Then, the water concentration of the solution was increased until a solution containing formic acid and water at a ratio of 1:1 (volume/volume) was obtained which turned slightly turbid. Then the solution was, under vigorous agitation, added into 700 ml of water kept at room temperature, whereby the hemicellulose acetate formed a dilute colloid, which did not settle out upon standing. The dispersed hemicelluose was concentrated immediately by centrifugation and again diluted with water and submitted to renewed centrifugation. Dilution and centrifugation were repeated until the pH of the dispersion was between 5 and 6. As a result, a 10 to 20% (by weight) paste was obtained which can be applied on the surface of paper with conventional means such as with a rod applicator. The product adheres well to the surface of paper and resembles white pigment coating.

### Example 7

### Production of a Hemicellulose Acetate Dispersion at Elevated Temperature

The starting situation and the composition of the aqueous formic acid solution were exactly the same as in Example 6. The solution of formic acid-water of the hemicellulose was fed into 700 ml hot (70° C.) water. The hemicellulose acetate colloid was formed equally well as in Example, 6 and it can be purified and concentrated with the same procedure as disclosed in Example 6. The use of hot water is advantageous in situations where the acetyl content is lower than in Example 4 and when hydrolysis of any formic acid potentially esterified with the hemicellulose is being aimed at.

The particle size of the dispersion was determined with a Lecotrac LT-100 laser particle size analyzer. 50% of the particles were >13 um and 96%<35 um. However, it was noticed from the electron microscope images that the particles were agglomerates in which the size of the individual particles was, indeed, very small.

Deagglomeration was demonstrated in small scale tests. For example, an average particle size of 250 nm was achieved with ultrasonic treatment.

### Example 8

### Production of a Dispersion of Birch Xylan

Xylan (3 g) was first dissolved in 100 ml formic acid by gently warming (at 40-60° C.), and then the solution was mixed at room temperature for 12 hours. Subsequently, the water concentration of the solution was increased to 50% by volume which resulted in a permanently turbid solution. After this, the hemicellulose solution was fed into 700 ml water of room temperature under vigorous agitation whereby xylan formed a non-settling white colloid. The colloid was concentrated and purified with the method described in Example 6. FTIR analysis of a dried sample of the paste showed that the product contained esterifying formyl groups, which indicates that dispersion of the product involved binding of the formic acid via an esterification reaction to the xylan.

In a comparative test, the potential formation of a colloid was assessed immediately after dissolution of the hemicellulose in the formic acid in which case the result was not a dispersion but a usual precipitate which will settle on the bottom of the liquid upon standing. The precipitate did not exhibit the white colour, which is characteristic of the products of Examples 6 and 7 and which in those cases indicates a small particle size and a light scattering fine structure of the colloid.

### Example 9

### Production of a Dispersion of Glucomannan Acetate

Production of glucomannan acetate dispersion was prepared according the method described in the Example 6. The solid content of the formed white and pasty dispersion was 13.7%.

### Dispersion Applications

The following examples are intended to demonstrate compositions that are useful in this invention and the benefits obtained when using the compositions. The Examples should not be construed as limiting the scope of the invention.

In Examples 10 to 12 conventional synthetic dispersions in pigment coatings for paper or board are partly or totally replaced with the xylan dispersion. The coating formulations can be applied onto paper and paperboard with a coating unit, dried, calendered and used as a printing surface for publication papers and packaging materials. Example 13 is an example of a barrier formulation where part of the oil-based dispersion has been replaced with xylan dispersion. Talc is added to further improve the barrier properties and to decrease blocking tendency.

The coating formulations according to Example 13 can be applied on-line in a paper or board machine with surface sizing or coating units, or in separate coating unit. Other types of formulations are useful in converting and printing units. During drying the dispersion particles form a non-porous barrier coating.

The barrier formulations can be used for various materials, such as polymer films, wrapping paper, corrugated board or paperboard, to be used in packaging applications. It is possible to obtain similar or enhanced barrier properties against gaseous and liquid compounds. Good resistance against water and solvents is also possible due to the low solubility of the polymer.

### Example 10

### Preparation of Xylan Dispersion

Xylan isolated from birch sulphate pulp is esterified with a short chain aliphatic carboxylic acid (CH₃(CH₂)ₙCOOH, n=0-3). Xylan dispersion is prepared by dissolving the fully acetylated xylan ester in formic acid and dispersing it into water under stirring. A stable aqueous xylan acetate dispersion without additional chemicals and with solids content of 10% is obtained by washing and concentrating the prepared dispersion.

### Pigment Slurry:

Aqueous pigment slurry is prepared by mixing 50 parts of fine ground calcium carbonate and 50 parts of kaolin clay using suitable dispersing agents or ready-made commercial slurries. The pH is adjusted to 8.5 with sodium hydroxide.

### Coating Formulation (See Table 1):

Xylan dispersion (5 or 2.5 parts dry polymer) together with commercial styrene/butadiene dispersion (5 or 7.5 parts dry polymer) is admixed to the pigment slurry (100 parts dry pigment). Carboxymethyl cellulose is added as rheology modifier and water retention agent if necessary.

TABLE 1
Coating color composition.

| Coating color | | | |
|---|---|---|---|
| compositions | 5XA/5L | 7.5XA/2.5L | 10L |
| Kaolin | 50 | 50 | 50 |
| CaCO3 | 50 | 50 | 50 |
| XA | 5 | 2.5 | — |
| Latex | 5 | 7.5 | 10 |
| Total solid contents % | 59 | 64 | 69 |
| pH | 8.5 | 8.5 | 8.5 |

XA = xylan acetate dispersion according to Example 7,
L = commercial latex.

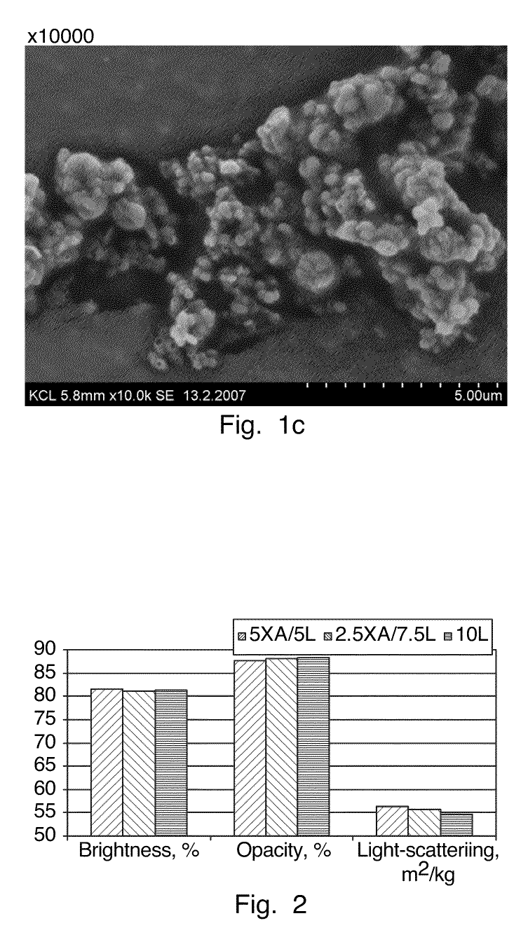

LWC base paper was coated using a laboratory sheet coater to a coat weight of 10 g/m². The coated sheets were calendered in a laboratory calendar at a speed of 120 m/min, a pressure of 80 kN/m, 3 nips and a temperature of 200° C. Similar optical properties were obtained for the coatings containing xylan acetate dispersion and the reference with 100% latex as binder component (FIG. 2).

### Example 11

Xylan acetate dispersion is prepared as above.

Pigment slurry is prepared as above.

### Coating Formulation:

Xylan dispersion (8 parts dry polymer) is admixed to the Pigment slurry (100 parts dry pigment) together with suitable plasticizer (2 parts dry), such as glycerol, sorbitol and triethyl citrate or mixture thereof.

Carboxymethyl cellulose can be added as rheology modifier and water retention agent.

### Example 12

Xylan acetate dispersion is prepared as above.

Aqueous Talc slurry (solids content of 55%) is prepared using suitable dispersing agents or ready-made commercial slurry.

### Coating Formulation:

Talc slurry (37 parts dry pigment) is admixed with xylan dispersion (50 parts dry polymer) and commercial styrene/butadiene barrier dispersion (50 parts dry polymer) together with suitable cross-linker.

Alkali-swellable thickener can be used as rheology modifier.

### Example 13

Production of a polymer film in 50/50 mixture with commercial latex:

A polymer film is prepared by adding 167 g of a 12 weight-% xylan acetate dispersion according to Example 7 to 20 g of a 50 weight-% dispersion of commercial styrene-butadiene latex and mixing in a Diaf mixer at 700-200 rpm. The pH is regulated to 8.5. Films on a plastic backing film are prepared with a draw-down coater with 200 um opening. The films are kept in an oven at 105° C. until dry and removed from the background thereafter.

Contact angle: With water 64.6 degrees, with di-iodomethane 50.6 degrees Equilibrate humidity of the film (50% relative humidity and 23 degrees): 4-5% Water absorbed in a water bath during 1 min: 7-8%

### Example 14

Acetylation of xylan of barley and preparation of dispersions thereof.

Barley xylan differs from the KCl xylan used in the previous examples in the respect that it contains a much greater part which is soluble. The following examples illustrate the acetylation and dispersion of Barley xylan, comparison being made to the method disclosed in Buchanan et al. (Preparation and characterization of arabinoxylan esters and arabinoxylan ester/cellulose ester polymer blends, Carbohydrate Polymers 52 (2003), 345-357).

Trial 1; Xylan as a whole acetylated

8.4 g Barley Xylan (solid content 95.4%, 8.00 g as dry weight, 0.05 mol) was mixed with 102.0 g of glacial acetic acid and 40.0 g (0.4 mol) of acetic anhydride. The mixture was heated for 10 min in 50° C., after that 0.100 g methane sulfonic acid (MSA) in 2 ml of acetic acid was added. The mixture was stirred and heated 60 min at 50° C. During the reaction period mixture remained heterogeneous. The cooled reaction mixture was filtered trough glass sinter and filtrate mixed with 500 ml of 8% acetic acid. Formation of precipitation or dispersion was not observed. An additional volume of 100 ml of water was added but the result still remained negative. The filtrate cake in glass sinter was dried and weighted: Yield: 3.7 g. FTIR spectrum revealed that degree of acetylation (1730-1734 cm⁻1 ester carbonyl, weak absorption) was very low.

The soluble part does not give a dispersion and the acetylation degree of the unsoluble part was low.

Trial 2 Acetylation of pre-fractionated Barley Xylan sample

The following trial was carried out according to the teaching of Buchanan et al.

A total of 30.0 g as dry weight of Barley Xylan was extracted with 1,385 g (pH 7) water by stirring vigorously 120 min with a magnet. The insoluble material was left to deposit for a period of 12 h in 1000 ml glass beaker before the contains was centrifuged 20 min to collect or remove any insoluble material. The solid content of clear, brownish supernatant liquid was measured to be 1.60%. Then the supernatant liquid was concentrated by Rotavapor to a solid content of 12.0%. A magnitude of 33.3 g sample, which equals 4.0 g of solids, of concentrated solution was mixed in portions, while mixing, with 350 ml of 100% acetic acid. The precipitate was let to deposit, after that flock like deposit was collected by pouring away the superimposed clarified liquid. Then the deposit was centrifuged three times with additional 100 ml portions of concentrated acetic acid as diluting liquid between centrifugation cycles. After the last centrifugation cycle the precipitate was mixed with 51 ml of 100% acetic acid followed by addition of 20.0 ml of acetic anhydride and 10 min heating period in 50° C. before 43 mg of MSA in 1.0 ml acetic acid was added for catalyst. During the reaction period of 60 min in 50° C. the reaction deposition dissolved. After reaction period reaction mixture was added to 250 ml of 8% acetic acid, and then diluted with additional 200 ml of water. Dilution of reaction mixture resulted in formation of precipitation with partly floats on surface; thus, a non-settling dispersion was not obtained by this method. In order to collect total amount of deposit, the whole sample was centrifuged and deposit washed in tubes. The weight of dried end product was 2.0 g, and an acetyl group contents of Xylan 27.5%. A yield of 50% calculated from the dry weight of starting material, the actual yield was lower, <50%, due to weight increase caused by acetylation.

FTIR: strong absorption: 1730-1734 cm⁻¹.

Trial 3. Method for acetylation

41.9 g Barley Xylan, 40.0 g as dry weight of Barley Xylan was combined with 267 g of 100% acetic acid 156 g of acetic anhydride and 8.8 g of 50 sodiumhydroxide solution in 45-50° C. Then the reaction mixture was heated 4-6 hours in 115° C. After that reaction mixture was diluted with excess (2000 ml) of water. The precipitate was collected by centrifugation and washed in tubes with water until pH was ˜5. The end product was dried overnight (50° C.) in convection oven.

Yield 51.6 g (129% yield calculated from dry weight of starting material), degree of acetylation 36.5% which is in good agreement with observed weight increase due to acetylation. FTIR: Strong absorption: 1730-1734 cm⁻¹ (See appendix FIG. 3)

The material was dissolved in formic acid and successfully dispersed as described in Example 6 under the heading “Preparation of hemicellulose dispersion”.

The examples show that both “A” and “B” types of xylan mentioned in the above Buchanan et al reference (A—insoluble, B—soluble), possibly present in different straws, can be efficiently acetylated and used as dispersion formulation for coating applications when the treatment/dispersion is carried out according to the present invention.

While the present invention has been illustrated and described with respect to a particular embodiment thereof, it should be appreciated by those of ordinary skill in the art that various modifications to this invention may be made without departing from the spirit and scope of the present invention.

What is claimed is:

1. An aqueous dispersion comprising a non-settling colloidal hemicellulose ester polymer in water.

2. The dispersion according to claim 1, consisting essentially of the hemicellulose ester in water.

3. The dispersion according to claim 1, wherein the hemicellulose ester is selected from esters of xylan, glucan, glucomannan and galactoglucomannan.

4. The dispersion according claim 3, wherein the hemicellulose ester is derived from a lower alkane acid, in particular the hemicellulose ester is a hemicellulose formate, acetate, propionate or butyrate.

5. The dispersion according to claim 4, wherein the hemicellulose ester is essentially insoluble or sparsely soluble in polar solvents.

6. The dispersion according to claim 1, having a solids content of 5 to 70%, preferably between 30 and 50%, calculated from the total weight of the dispersion.

7. The dispersion according to claim 1, wherein the dispersion comprises hemicellulose agglomerates, 80% of which are smaller than 35 um, as determined with a laser particle size analyzer.

8. The dispersion according to claim 1, wherein the hemicellulose ester exhibits a degree of esterification of 5 to 50%, based on the total weight of the ester.

9. The dispersion according to claim 1, wherein the pH of the dispersion is about 3 to 8.5, preferably 7.0 or below, typically about 4.5 to 6.5.

10. The dispersion according to claim 1, wherein the hemicellulose ester comprises xylan acetate, derived from an essentially linear chain of beta-D-xylopyranose units.

11. The dispersion according to claim 1, wherein the hemicellulose ester comprises glucomannan acetate, derived from an essentially linear chain of glucomannos units.

12. The dispersion according to claim 1, wherein the hemicellulose ester exhibits an average molecular weight (M_{w}) in the range of about 1,000 to 30,000 g/mol, in particular about 5,000 to 20,000, preferably about 7,500 to 17,500 g/mol.

13. A method of producing a stable dispersion according to claim 1, comprising the steps of
providing an esterified hemicellulose wherein at least a part of the esterifying groups are derived from a lower alkanoic acid;
dissolving the esterified hemicellulose in formic acid to produce a solution having a volume;
diluting said solution with water; and
dispersing the water-diluted solution into a volume of water which is greater than the volume of the original ester solution to produce an aqueous dispersion of the hemicellulose ester.

14. The method according to claim 13, wherein said solution is diluted with water, which is used in a volume which is 0.1 to 10 times the volume of the solution to produce a water-diluted solution; and the water-diluted solution is fed under intensive agitation into a volume of water which is 1.5 to 50 times, preferably 2 to 20 times, greater than the volume of the original ester solution.

15. The method according to claim 13, wherein the hemicellulose ester comprises
a xylan ester having a degree of substitution in excess of 1.5, preferably 1.75 or more, in particularly about 1.9 or more, or a glucomannan or galactoglucomannan ester having a degree of substitution in excess of 2.0, preferably at least 2.5 or even 2.75.

16. The method according to claim 13, wherein the solution with the dissolved hemicellulose ester is flash diluted in water.

17. The method according to claim 13, wherein the dispersed phase is concentrated and washed with water using at least one method selected from ultrafiltration, microfiltration, decantation, centrifugation and combinations thereof.

18. A method of modifying substrates comprising:
applying a polymer to the substrate wherein the polymer comprises from 1 to 100 parts by weight of xylan ester of low solubility.

19. The method according to claim 18, wherein the xylan is esterified with a short chain aliphatic carboxylic acid.

20. The method according to claim 18, wherein the xylan is isolated from plants or it is isolated from pulp made from plants.

21. The method according to claim 18, wherein the plants are trees, preferably hardwood species, such as birch or the like.

22. The method according to claim 18, wherein the polymer is in the form of aqueous dispersion.

23. The method according to claim 18, wherein the aqueous dispersion further comprises pigments particles, in particular selected from the group consisting of gypsum, silicate particles, talc particles, plastic pigment particles, kaolin particles, mica particles, calcium carbonate particles, bentonite particles, alumina trihydrate particles, titanium dioxide particles, phyllosilicate particles, synthetic silica particles, organic pigment particles and mixtures thereof.

24. The method according to claim 23, wherein the proportion of pigment particles is typically between 50 and 97%, most typically between 70 and 91% calculated of coating dry matter.

25. The method according to claim 18, wherein the dispersion further comprises in addition one or more additional components.

26. The method according to claim 25, wherein said additional component is selected from the group consisting of antifoaming agents and salts, defoaming agents and salts, biocides and preservatives, surface tension agents, water retention agents, rheology modifiers, dispersing agents, plasticising agents, lubricants, optical brightening agents, colouring agents, cross-linkers, waxes, volatile alkalis and hydrophobic agents.

27. The method according to claim 18, wherein the substrate is selected from kraft paper, paperboard, cardboard, corrugated board, ream wrap, printing paper, greaseproof paper or the like.

28. The method according to claim 18, wherein the substrate is a plastic, polymer film, polymer coated paper, polymer coated paperboard, nonwowen or the like.

29. The method according to claim 18, wherein the substrate is wood, concrete, stone, metal, brick, veneer, fibrewood, fibreglass or the like.

30. The method according to claim 18, wherein the polymer is admixed with from 10 to 99 parts, preferably less than 50 parts by weight of a water-soluble component and the admixture is applied to a substrate.

31. The method according to claim 30, wherein the water-soluble component is selected from the group consisting of starch, polyvinyl alcohol, dextrin, protein, carboxymethyl cellulose, water-soluble hemicelluloses and resins and mixtures thereof.

32. The method according to claim 18, wherein the polymer is admixed with from 10 to 99 parts, preferably less than 50 parts by weight of a second dispersion and the admixture is applied to a substrate.

33. The method according to claim 32, wherein the second dispersion is selected from the group consisting of butyl acrylate/methyl methacrylate, butyl acrylate/styrene, styrene/butadiene, and vinyl acetate dispersions and mixtures thereof.

34. The method according to claim 18, wherein modifying refers to internal or surface sizing, impregnating, coating, painting, printing, lacquering or the like.
